(19) United States
(12) Patent Application Publication
(10) Pub. No.: US 2004/0061680 A1
(43) Pub. Date: Apr. 1, 2004

(54) Method and apparatus for computer control

(76) Inventor: John Taboada, San Antonio, TX (US)

Correspondence Address: Dr. John Taboada, 12530 Elm Country, San Antonio, TX, 78230, US

(21) Appl. No.: 10/614,261

(22) Filed: Jul. 7, 2003

Related U.S. Application Data
(60) Provisional application No. 60/394,735, filed on Jul. 10, 2002.

(51) Int. Cl. G09G 5/08

(52) U.S. Cl. 345/157

(57) ABSTRACT

The method and apparatus for computer control presented here is based on the novel use of laser produced speckle light patterns and a solid state optical mouse sensor. Two apparatuses for computer control are disclosed, one based on head movement and the other on finger tip movement. Both systems operate on the principle of imaging a speckle pattern onto a solid state optical mouse sensor and translating the movement of the speckle pattern into cursor movement. For the head tracker, the speckle pattern may be generated by passing a laser beam into the end of a fiber-optic bundle or into a specially generated holographic element. For the finger tip tracker, the speckle pattern is generated by focusing a laser beam onto the finger tip. For both types of computer control devices, the solid state optical mouse sensor that may be utilized is a HDNS-2000 sensor element from Agilent Technologies.

The method and apparatus for computer control presented here is based on a novel use of laser produced speckle light patterns and the Agilent Technologies HDNS-2000 Solid State Optical Mouse Sensor (HDNS-2000) taken in conjunction with voice recognition.

Technical specifications of the HDNS-2000 are reproduced in Appendix 1. The HDNS-2000 works by imaging a patterned surface illuminated by incoherent light onto a 22×22 array of photo sensors. The navigational data for cursor positioning is generated by a digital signal processing of the sensor array output as described in U.S. Pat. No. 6,233,368 B1, May 15, 2001, Appendix 2. Referring to FIG. 1, the principle of the HDNS-2000 chip function can be described as follows. Essentially incoherent illumination from a bright LED illuminates a patterned source in close proximity to the receiving optics and the sensor array. The sensor array images the pattern in finite conjugates. The image is processed by the digital signal processor section to yield x-y position date for the mouse cursor through the usual PC port. The limitations of this art are that the illumination must be significantly intense, the patterned surface must be maintained in the object plane for sharp focusing and there must be substantial motion of the patterned surface to obtain reasonable x-y signal variation. This compels the art to take the form of a large hand held device moving to take the form of a large hand held device moving over substantial space on a selected surface.

### 1. NOVEL CONCEPT 1-SPECKLE PATTERN CONTROL OF THE HDNS-2000

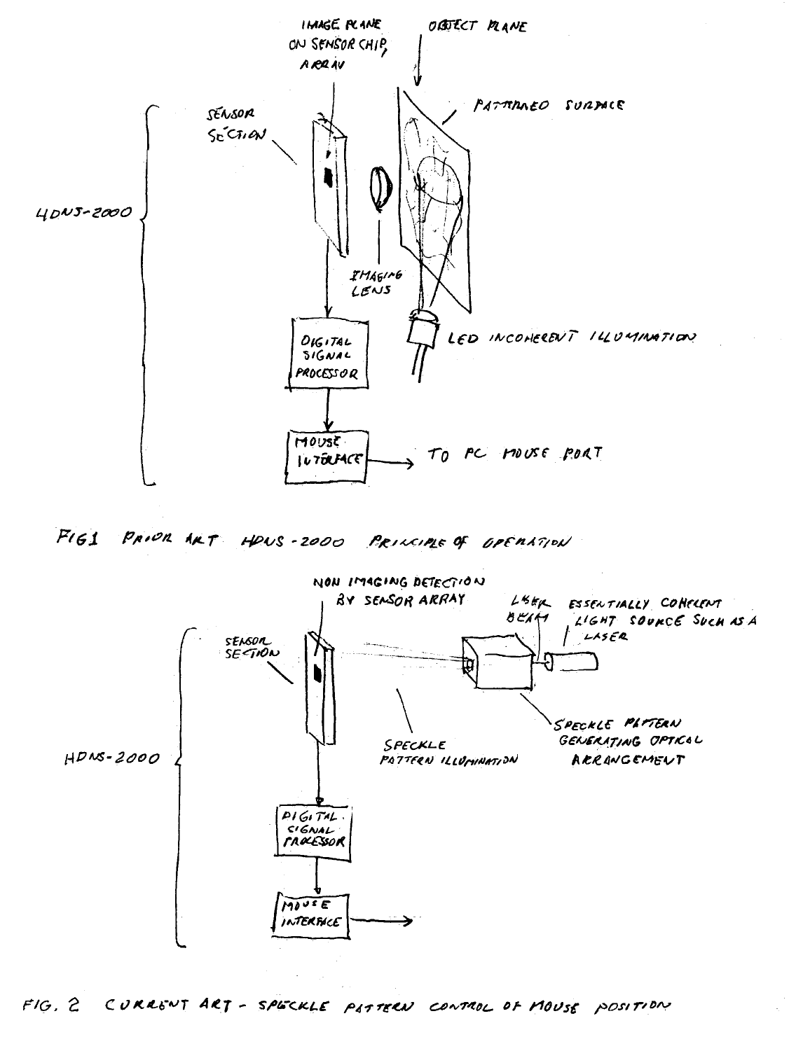

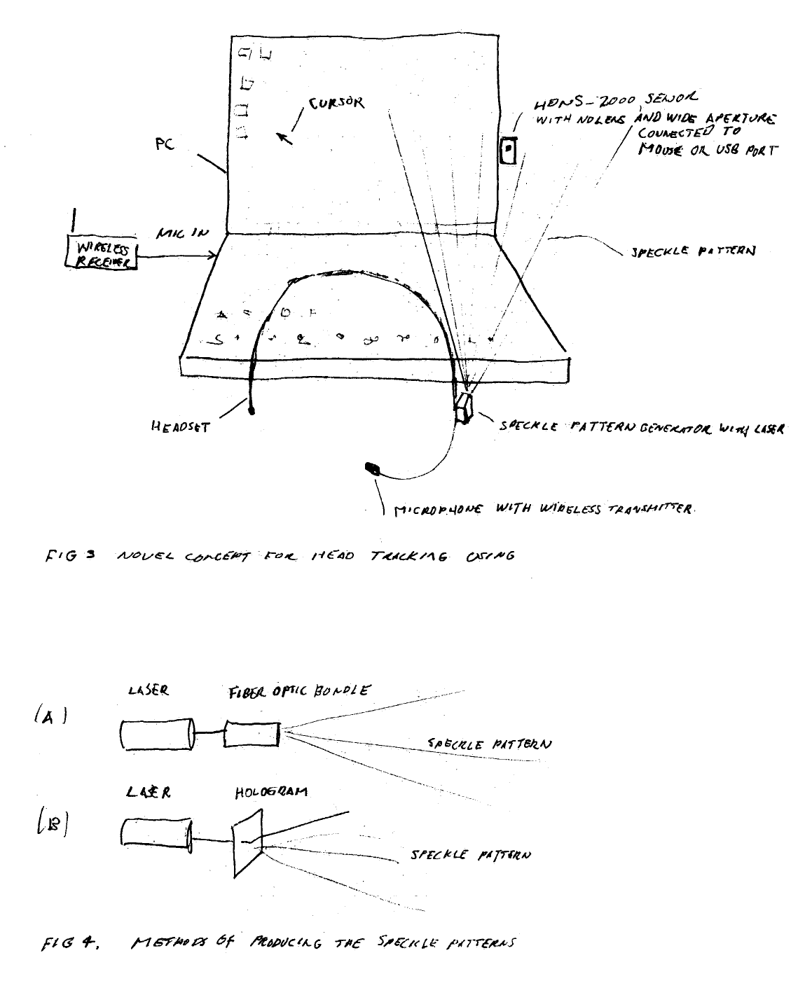

To overcome these limitations so as to provide new and novel features, the invention modification of FIG. 2 is suggested. In this novel arrangement, the imaging lens is eliminated in the conventional sensor as well as any apertures lying in front of the detector array. This permits the detector array to capture a very large angular subtense. In addition, the sensor is illuminated with a speckle pattern generated by a speckle pattern generating optical generating arrangement, to be described in more detail in the following. The speckle pattern is produced by an essentially coherent light source such as a laser. Motion at the speckle pattern relative to the sensor array produces the desired x-y motion of the mouse cursor. Relative motion of the speckle pattern generating optics can be accomplished by 1) movement of the sensor array relative to a stationary spectacle pattern; 2) movement of the speckle pattern generating optics relative to a stationary sensor array and laser beam; 3) movement of the coherent light source relative to the speckle pattern generating optics; and 4) movement of the combined speckle pattern generating optical arrangement taken in conjunction with the laser relative to the sensor array, and the other combinations. Thus the options for the application of HDNS-2000 have increased multiples. The speckle pattern generating optical arrangement of FIG. 2 is discussed in detail in the novel application of the concept to a head movement and to a finger tip controlled mouse. Novel use is made of voice recognition for these two inventive concepts.

2. Head Movement and Voice Recognition Controlled Mouse

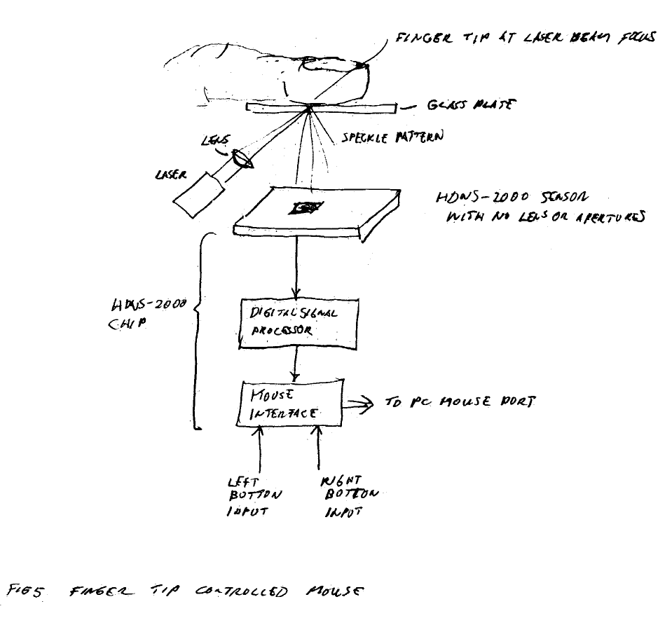

The head movement and voice controlled mouse is diagrammed in FIG. 3. It is comprised of an HDNS 200 sensor connected to the mouse port of the computer. The sensor has no lens and no aperture in front of the chip. The operator places the headset on his head and controls the cursor position by moving a laser produced cone shaped pattern across the HDNS-2000 sensor. The sensor is connected to the mouse port. The movement of the speckle pattern is translated into cursor movement. A microphone with preferably a wireless transmitter is attached to the headset. Voice commands enter the computer on the microphone input to the computer. Voice recognition's software which is regularly provided by Microsoft in their latest operating system is used to recognize verbal commands such as “open”, “press”, “drag”, “drop” and “click.” The speckle pattern can be produced by the methods illustrated in FIG. 4. In (A) the speckle pattern generator is comprised of a solid state laser beamed into the end of a fiber-optic bundle. The multiple refractions and reflections of the beam as it passes through the bundle creates the desired speckle pattern. In (B), a laser is beamed into a specially generated holographic element to produce the desired structured diffractive laser light pattern.

3. Finger Tip and Voice or Button Controlled Mouse

This application is illustrated in FIG. 5. The speckle pattern is produced by focusing a laser beam onto a finger tip through a supporting glass plate. The focused laser beam generates a speckle pattern that falls on the HDNS-2000 sensor element. A lens may be interposed in this region, in the space between the finger tip and the HDNS-2000 sensor, to enhance the resolution. Motion of the speckle pattern relative to the sensor array is accomplished by moving the finger in two dimensions over the supporting glass surface. The speckle pattern motion is converted into corresponding cursor position changes by mean of the digital signal processor. Mouse button push commands can be fed into the data stream with usual input interfaces. Alternatively, a voice recognition interface can be established as was done for the previously discussed head tracking methods.

A number of embodiments of the present invention have been described. Nevertheless, it will be understood that various modifications may be made without departing from the spirit and scope of the invention. Accordingly, it is to be understood that the invention is not to be limited by specific illustrated embodiment, but only by the scope of the appended claims.

What is claimed is:

1. An apparatus for controlling the position of a cursor marker on a computer monitor screen and selecting the computer action such as on-screen virtual button pushing, icon positioning, and file actions such as opening or closing, comprising:
a headset based on the computer operator's head having a laser speckle or interference pattern generator affixed there onto projecting a laser speckle pattern generally onto the computer screen
a microphone with wireless transmitter connected to the headset
a small battery power source for the speckle pattern generating laser and wireless transmitter housed in the headset
a solid state optical mouse sensor affixed to the side of the computer screen and positioned such that it receives the speckle or interference pattern
a wireless receiver conveying the spoken instructions of the operator into the microphone port of the computer.

2. The apparatus of claim 1 where said computer is an IBM PC type with typically a Microsoft Windows XP operating system.

3. The computer of claim 2 where said computer is programmed to understand through word recognition software, spoken audible commands corresponding to computer commands normally entered on the keyboard or launched by a virtual button push with a computer mouse button.

4. The apparatus of claim 1 where said headset moves with the operator's head movement.

5. The apparatus of claim 1 where said laser speckle pattern generator is comprised of a low power solid state laser projecting a beam into a fiber optic bundle or a holographic plate to produce a speckle pattern with motion exactly correlated to the motion of the operator's head.

6. The apparatus of claim 1 where said microphone communicates the spoken commands by the computer operator to said wireless transmitter of the apparatus of claim 1.

7. The apparatus of claim 1 where said wireless transmitter communicates by electromagnetic means.

8. The apparatus of claim 1 where said wireless receiver communicates the spoken commands into the microphone port of the computer.

9. The apparatus of claim 1 where said solid state optical mouse sensor may essentially be of the type manufactured by Agilent Technologies and designated as HDNS-2000.

10. The solid state optical mouse sensor of claim 9 where said sensor is connected to supporting circuits which are in turn connected to the USB or mouse port of the computer.

11. The supporting circuits of claim 10 where said circuits are the circuits recommended by the sensor manufacture.

12. The solid state sensor of claim 10 where said sensor has the lens and aperture removed so as to permit the speckle or interference pattern to impinge on the complete sensor surface.

13. The apparatus of claim 1 where said wireless transmitter and wireless receiver may be of the Bluetooth type.

14. A method for controlling the position of a cursor marker on a computer monitor screen and selecting the computer action such as on-screen virtual button pushing, icon positioning, and file action, such as opening or closing, comprised of the following steps:
moving a headset with corresponding head movement
moving a corresponding laser produced speckle pattern across the sensor surface of a properly prepared solid state optical mouse sensor
controlling the motion of the computer cursor with the output of the solid state optical mouse sensor
speaking computer commands into a microphone attached to the headset
transmitting the spoken commands to a wireless receiver
converting the wireless transmitted signals into audio signal inputs to the computer
understanding the spoken command by the computer using voice recognition programming.

15. The method of claim 14 where said headset moving corresponds to desired movement of the cursor on the computer monitor screen.

16. The method of claim 14 where said computer cursor motion controlling is accomplished by the process characteristic of the solid state optical mouse sensor except that the left-right designation must be reversed electronically or in computer software.

17. The method of claim 14 where said spoken command understanding is done by conventional voice recognition software such as found in the Microsoft XP operating system.

18. An apparatus for controlling the position of a cursor marker on a computer monitor screen by using small movements of the computer operator's finger, comprising:
a glass plate upon which the computer operator's controlling finger is placed
a laser beam focused onto the surface of said finger through said glass plate upon which said finger rests
a solid state optical mouse sensor with fixed position relative to the focused laser beam and said glass plate
an interface circuit connecting to the USB or mouse port of the computer.

19. The apparatus of claim 18 where said laser beam focused onto said finger generates a speckle pattern.

20. The laser speckle pattern of claim 19 where said speckle pattern moves with corresponding movement of the operator's finger of claim 18.

21. The speckle pattern of claim 19 where said speckle pattern is made to impinge on the entire sensor surface of the solid state optical mouse sensor of claim 18.

22. The apparatus of claim 18 where said solid state optical mouse sensor may essentially be of the type manufactured by Agilent Technologies and designated HDNS-2000.

23. The solid state optical mouse sensor of claim 22 where said solid state optical mouse sensor has the lens and aperture removed so as to permit the speckle pattern to impinge on the complete sensor surface.

24. The apparatus of claim 18 where said interface circuit is of the type suggested by the manufacture of said solid state optical mouse sensor.

25. A method for controlling the position of a cursor marker on a computer monitor screen by using small movements of the computer operator's finger comprised of the following steps:
placing the controlling finger on a glass plate
projecting a focused laser beam through the glass plate onto said finger
projecting a scattered speckle pattern from said finger onto the sensor surface of a solid state optical mouse sensor
moving the finger so as to move the corresponding laser speckle pattern
converting said speckle pattern movement into cursor position movement on the computer monitor screen.
